(19) United States
(12) Patent Application Publication
(10) Pub. No.: US 2013/0211619 A1
(43) Pub. Date: Aug. 15, 2013

(54) METHOD AND DEVICE FOR OPERATING A VEHICLE

(71) Applicants: Martin KIEREN, Marbach A.N. (DE); Thomas HAEUSSLER, Kuenzelsau-Vogelsberg (DE)

(72) Inventors: Martin KIEREN, Marbach A.N. (DE); Thomas HAEUSSLER, Kuenzelsau-Vogelsberg (DE)

(73) Assignee: Robert Bosch GmbH, Stuttgart (DE)

(21) Appl. No.: 13/760,869

(22) Filed: Feb. 6, 2013

(30) Foreign Application Priority Data
Feb. 10, 2012 (DE) 10 2012 201 979.0

(51) Int. Cl. G08G 1/16

(52) U.S. Cl. CPC G08G 1/16
USPC 701/1

(57) ABSTRACT

A method, device, system, and computer program for operating a vehicle, in case of a detection of a vehicle avoidance maneuver a driver assistance system being activated for a lateral vehicle dynamics control.

### CROSS REFERENCE

The present application claims the benefit under 35 U.S.C. §119 of German Patent Application No. DE 102012201979.0 filed on Feb. 10, 2012, which is expressly incorporated herein by reference in its entirety.

### FIELD

The present invention relates to a method and a device for operating a vehicle. Furthermore, the present invention relates to a system for operating a vehicle and a computer program.

### BACKGROUND INFORMATION

Conventionally, a vehicle with driver assistance systems may be provided which are able to provide assistance functions which, based on an environmental sensor system, such as radar or a video camera, estimate the danger of rear-end collisions and make active interventions via a braking actuator system, in order thereby to avoid accidents or at least to minimize the severity of an accident. However, such assistance functions are only active, that is, the corresponding driver assistance systems are only active if the driver does not initiate any avoidance maneuver to prevent the accident.

European Patent No. EP 1 735 187 B1 describes an anti-collision system for a vehicle as well as a corresponding method.

A method and a device for the automatic triggering of the deceleration of a vehicle are described in German Patent No. DE 102 31 584 A1. In this case, an emergency braking function is activated only at a later time, or is even completely deactivated when the driver undertakes an emergency avoidance maneuver.

### SUMMARY

An object of the present invention is to provide an improved method and an improved device for operating a vehicle, whereby in a situation of danger an accident is able to be avoided or at least the severity of an accident is able to be minimized.

An object of the present invention includes providing a corresponding system for operating a vehicle.

An object on which the present invention is based also includes providing a corresponding computer program.

According to one aspect of the present invention, an example method for operating a vehicle is provided. In this instance, it is provided that, in the case of the detection of a vehicle avoidance maneuver a vehicle assistance system is activated for a lateral driver dynamics control.

According to one further aspect, a device for operating a vehicle is provided. The device includes a detection apparatus for detecting a vehicle avoidance maneuver. The device also includes an activation apparatus for activating a driver assistance system for a lateral vehicle dynamics control as a function of the detected avoidance maneuver.

According to still another aspect, a system is provided for operating a vehicle in which the system includes the device for operating a vehicle as well as a driver assistance system for a lateral vehicle dynamics control

According to a further aspect, an example computer program is provided, which includes program code to execute the method for operating a vehicle when the computer program is run on a computer.

Thus, an example embodiment of the present invention includes detecting a vehicle avoidance maneuver, this means in particular of recognizing it, whereupon the driver assistance system is then activated for a later vehicle dynamics control. Thus, the driver assistance system is activated only when a vehicle avoidance maneuver is being executed. For the reason that, in the case of a vehicle avoidance maneuver, the driver assistance system is activated for a lateral vehicle dynamics control, this driver assistance system is able to support a driver during the vehicle's avoidance maneuver in an advantageous manner, so that an accident is able to be avoided or at least the severity of the accident is able to be minimized. Thus, for example, based on a panic reaction, a driver may unnecessarily steer the steering wheel too far, so that the vehicle could begin to skid, for example. The driver assistance system, in this case, may then, for example, ignore the excessive steering on the part of the driver to the extent that only meaningful steering, that is adapted to the situation, is taken into account.

A driver assistance system within the meaning of the present invention particularly designates a system which autonomously or partially autonomously intervenes in the drive, the control, such as, for instance, gas or brake, and/or a signaling device of the vehicle shortly before, or during a critical situation. A driver assistance system in accordance with the present invention in particular is designed to warn a driver shortly before or during a critical situation, using a man-machine interface. The driver assistance system is particularly developed to brake or accelerate, as the case may be, one or more wheels of the vehicle, particularly in each case independently of one another. The driver assistance system is preferably developed to intervene in a steering system of the vehicle, so that the driver assistance system is able to steer the vehicle partially autonomously or autonomously.

The driver assistance system for a lateral vehicle dynamics control is particularly a driver assistance system that is able to control the lateral vehicle dynamics. Lateral, in this instance, means particularly in the direction towards the side. It thus means in particular that the driver assistance system for a lateral vehicle dynamics control intervenes autonomously, or partially autonomously, in the individual vehicle systems such as the drive, steering, control or signaling devices if the vehicle moves towards the side, that is, if it deviates from its original trajectory. Such a lateral vehicle dynamics control differs particularly from an emergency braking system providing an emergency braking function to the extent that the emergency braking system intervenes only in the longitudinal direction, that is, in the direction of a longitudinal axis, in this case, in the direction of the original vehicle trajectory, just to decelerate the vehicle. Such a system, however, does not support the driver if the driver is carrying out an avoidance maneuver, i.e., is deviating from his original travel trajectory, that is, if he is driving towards to side.

A vehicle avoidance maneuver within the meaning of the present invention designates especially a maneuver whereby the vehicle is maneuvering around an obstacle, in order to avoid a collision or to reduce the severity of an accident. It may be provided, for example, that such a vehicle avoidance maneuver be initiated, and particularly carried out, by corresponding vehicle assistance systems autonomously or partially autonomously. It may be preferably provided that such a vehicle avoidance maneuver be initiated and particularly carried out by a driver.

In order for not every vehicle maneuver to be recognized or detected or classified as a vehicle avoidance maneuver, one or more criteria may preferably be provided which may be present or satisfied so that a vehicle maneuver is detected or recognized or classified as a vehicle avoidance maneuver. Such exemplary criteria, which may be present in particular each by itself or, for instance, together or preferably only a few together, are described below.

According to one specific example embodiment, it may be provided that the detection of the vehicle avoidance maneuver include the recording of a driver steering angle, which is greater than a predetermined driver steering angle threshold value. This, therefore, means in particular that a vehicle avoidance maneuver is recognized only or detected as such only if a driver steering angle is recorded that is greater than a predetermined driver steering angle threshold value. This, therefore, means in particular that the driver assistance system is activated only if the recorded driver steering angle is greater than the predetermined driver steering angle threshold value. Such a driver steering angle threshold value may preferably amount to 5°. In this connection, 0° designates the driver steering angle at which the vehicle is traveling straight ahead along its longitudinal axis, that is, the axis along its greatest extension.

According to another specific embodiment, it may be provided that the detection of the vehicle avoidance maneuver include the recording of a steering wheel angular velocity, which is greater than a predetermined steering wheel angular velocity threshold value. This, therefore, means in particular that the vehicle avoidance maneuver is only recognized or detected as such if the recorded steering wheel angular velocity is greater than a predetermined steering wheel angular velocity threshold value. This, therefore, means in particular that the driver assistance system is activated only if the recorded steering wheel angular velocity is greater than the predetermined steering wheel angular velocity threshold value. Generally, in the case of an avoidance maneuver, the driver will provide a greater steering wheel angular velocity than in the case of a normal passing maneuver or regular cornering. This being the case, because of the provision of a predetermined steering wheel angular velocity threshold value, it may advantageously be ensured that not every normal passing maneuver leads to the activation of the driver assistance system. Consequently, the misuse of the driver assistance system on the part of the driver is advantageously avoided. The steering wheel angular velocity threshold value may preferably be 70°/s.

For example, it may be provided that the steering wheel angular velocity be low-pass filtered. This then means particularly that the corresponding steering wheel angular velocity signals, which may in particular be provided using a steering wheel sensor, are filtered using a low-pass filter. Since usually steering wheel angular velocity signals have high frequencies, in an advantageous manner one may consequently filter out a corresponding frequency range, which results in a clear signal, and this being so, makes possible robustness and also advantageously allows an early activation of the driver assistance system.

According to another specific embodiment, it may be provided that the detection of the vehicle avoidance maneuver include the recording of a required propulsion power, which is less than a predetermined propulsion power threshold value.

This, therefore, means in particular that the driver assistance system is activated only if the recorded required propulsion power is less than the predetermined propulsion power threshold value. Generally, the situation is that, when a driver wants to carry out a vehicle avoidance maneuver, he no longer asks for propulsion power, so that there may be a further criterion present here, which indicates that there is present or that there is being carried out a vehicle avoidance maneuver, whereupon the driver assistance system is activated for a lateral vehicle dynamics control. Propulsion power may be put into effect, for example, by operating a gas pedal. In this respect, for instance, the setting of a gas pedal may be recorded. In particular, when such a gas pedal is not operated, one may assume that the driver is not requiring any propulsion power. The predetermined propulsion power threshold value is then particularly zero in this case. Thereby, advantageously, the misuse of the driver assistance system for a lateral driving dynamics control is additionally avoided in normal passing maneuvers.

According to one additional specific embodiment, it may be provided that the detection of the vehicle avoidance maneuver includes recording a predetermined operating state of a signaling device of the vehicle. This, therefore, means in particular that the driver assistance system is activated only if the operating state of the signaling device corresponds to a predetermined operating state. This, then, means in particular that a vehicle avoidance maneuver is detected or recognized as such if a predetermined operating state of a signaling device of the vehicle is recorded. This especially means that the signaling device has to have a predetermined operating state before a vehicle avoidance maneuver is detected or recognized as such. Preferably, it is also possible to provide multiple signaling devices, which may have the same or a different design.

According to one specific embodiment, the detection of the vehicle avoidance maneuver may include the recording of an off-operating state of a direction indicator of the vehicle. This means in particular that, when it is recorded that the direction indicator is in an off-operating state, that is, it is deactivated, a vehicle avoidance maneuver is detected or recognized as such. The direction indicator signals, particularly optically, an anticipated travel direction of the vehicle. The direction indicator may preferably include one or more lamps, which are able to indicate a direction change, especially by blinking. In everyday jargon, the term “blinker” has come to mean direction indicator. As a rule, in a critical driving situation, the driver will no longer operate the direction indicator, that is, put it in an on-operating state, for he will usually no longer have the time to do this. Thus, according to the abovementioned specific embodiment, the driver assistance system is not activated for a lateral vehicle dynamics control, if the direction indicator is in an on-operating state. Thus, it will be activated if the direction indicator is in an off-operating state.

According to one additional specific embodiment, it may be provided that the detection of the vehicle avoidance maneuver includes recording an on-operating state of a brake light of the vehicle. This, therefore, especially means that the detection of a vehicle avoidance maneuver is only recognized or detected as such, if a brake light is in an on-operating state. This means especially that the driver assistance system is activated for a lateral vehicle dynamics control only if the brake light is in an on-operating state. An on-operating state of the brake light particularly designates an operating state in which the brake light is activated, and this being the case, is able to indicate optically that the driver has, for instance, operated a brake pedal and/or the vehicle speed is particularly decreased or decelerated.

In one specific embodiment that is not shown, it may be provided that the detection device includes one or more sensors which, for example, are able to record by sensor a driver steering angle and/or a steering wheel angular velocity and/or a required propulsion power, in particular, a gas pedal setting and/or an operating state of a signaling device of the vehicle.

The present invention is explained below in greater detail with reference to preferred exemplary embodiments.

### BRIEF DESCRIPTION OF THE DRAWINGS

FIG. 1 shows a flow chart of a method for operating a vehicle.

FIG. 2 shows a device for operating a vehicle.

FIG. 3 shows a system for operating a vehicle.

FIG. 4 shows a flow chart of an additional method for operating a vehicle.

FIG. 5 shows a graphic representation of various criteria for detecting or recognizing a vehicle avoidance maneuver as such.

### DETAILED DESCRIPTION OF EXAMPLE EMBODIMENTS

In the following text, the same reference numerals are used for the same features.

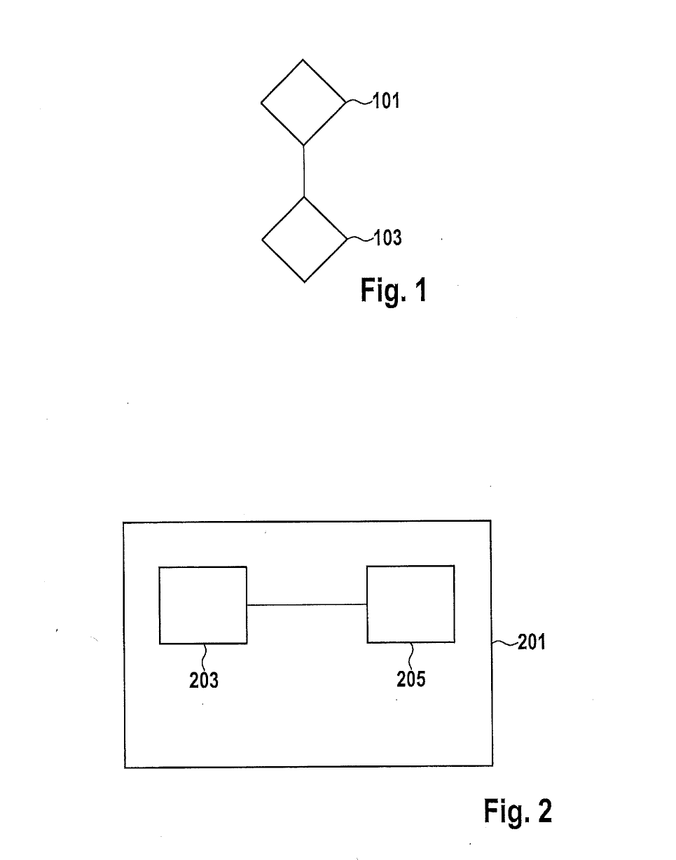

FIG. 1 shows a flow chart of an example method for operating a vehicle. If a vehicle avoidance maneuver is detected in step 101, a driver assistance system for a lateral vehicle dynamics control is activated in a step 103. In an advantageous manner, the driver may thus be given support for the vehicle avoidance maneuver. It may particularly be provided in this instance that the driver assistance system for a lateral vehicle dynamics control, during the vehicle avoidance maneuver, accelerates one or more tires of the vehicle, particularly each independently of one another, or brakes them or decelerates them. Consequently, for example, a traffic lane may advantageously be held better, to the extent that breaking out of it or skidding of the vehicle may advantageously be avoided. The driver assistance system is, for instance, able to intervene in the steering of the vehicle.

In order for not every vehicle maneuver to be recognized or detected or classified as a vehicle avoidance maneuver, one or more criteria may be provided which must be present or satisfied so that a vehicle maneuver is detected or recognized as a vehicle avoidance maneuver.

It may be provided, for example, that a driver steering angle be greater than a predetermined driver steering angle threshold value, so as to be able to detect or recognize a vehicle maneuver as a vehicle avoidance maneuver.

It may preferably be provided that a steering wheel angular velocity, especially a low-pass filtered steering wheel angular velocity be greater than a predetermined steering wheel angular velocity threshold value, so as to be able to detect or recognize or classify a vehicle maneuver as a vehicle avoidance maneuver.

It may preferably be provided that, as a criterion for the detection of a vehicle avoidance maneuver, a recorded, required propulsion power be smaller than a predetermined propulsion power threshold value. In this case, the setting of a gas pedal may preferably be recorded, it being provided, for example, that the criterion of a vehicle avoidance maneuver is satisfied in a non-operated gas pedal setting.

It may also be provided, for example, that an operating state of a signaling device of the vehicle is recorded, whereby, if the recorded operating state corresponds to a predetermined operating state, a vehicle maneuver is classified or detected as a vehicle avoidance maneuver, so that thereupon the driver assistance system is activated for a lateral vehicle dynamics control, so that this is then advantageously able to control the lateral vehicle dynamics.

FIG. 2 shows a device 201 for operating a vehicle (not shown). Device 201 includes a detection device 203, which is developed to detect a vehicle avoidance maneuver of the vehicle. This means particularly that detection device 203 is developed to classify or recognize a vehicle maneuver as being a vehicle avoidance maneuver if one or more criteria are satisfied. Such criteria may particularly be the abovementioned criteria.

Device 201 also includes an activating device 205, which is developed to activate a driver assistance system (not shown here) for a lateral vehicle dynamics control, this activation being carried out only if a vehicle maneuver is recognized as a vehicle avoidance maneuver. This especially means that the driver assistance system is activated for a lateral vehicle dynamics control as a function of the detected vehicle avoidance maneuver.

In one specific embodiment that is not shown, it may be provided that the detection device 203 includes one or more sensors which, for example, are able to record by sensor a driver steering angle and/or a steering wheel angular velocity and/or a required propulsion power, in particular, a gas pedal setting and/or an operating state of a signaling device of the vehicle.

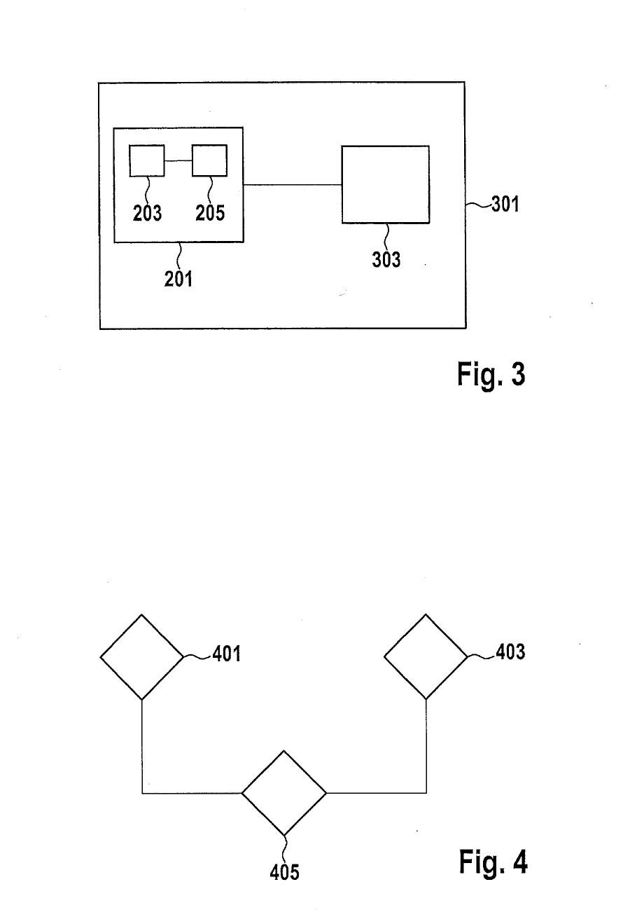

FIG. 3 shows a system 301 for operating a vehicle. System 301 includes device 201 according to FIG. 2 as well as a driver assistance system 303 for a lateral vehicle dynamics control. This means particularly that driver assistance system 303 is developed to control lateral vehicle dynamics. Because of this, driver assistance system 303 is advantageously in a position to support a driver in his avoidance maneuver, so that, in this instance, an accident is able to be avoided or at least the severity of an accident may be minimized.

FIG. 4 shows a flow chart of a further method for operating a driver assistance system of a vehicle.

According to a step 401, a driver steering angle is monitored to see whether it is greater or less than a predetermined driver steering angle threshold value. According to a step 403, which is particularly carried out simultaneously with step 401, it is monitored whether a steering wheel angular velocity, particularly a low-pass filtered steering wheel angular velocity, exceeds a predetermined steering wheel angular velocity threshold value. Such a threshold value may amount, for instance, to 70°/s.

If the driver steering angle is greater than the predetermined driver steering angle threshold value and if the steering wheel angular velocity is greater than the predetermined steering wheel angular velocity threshold value, the driver assistance system is activated in a step 405 for a lateral vehicle dynamics control, to the extent that, based on the two satisfied criteria according to steps 401 and 403, a corresponding vehicle maneuver has been detected or recognized as a vehicle avoidance maneuver.

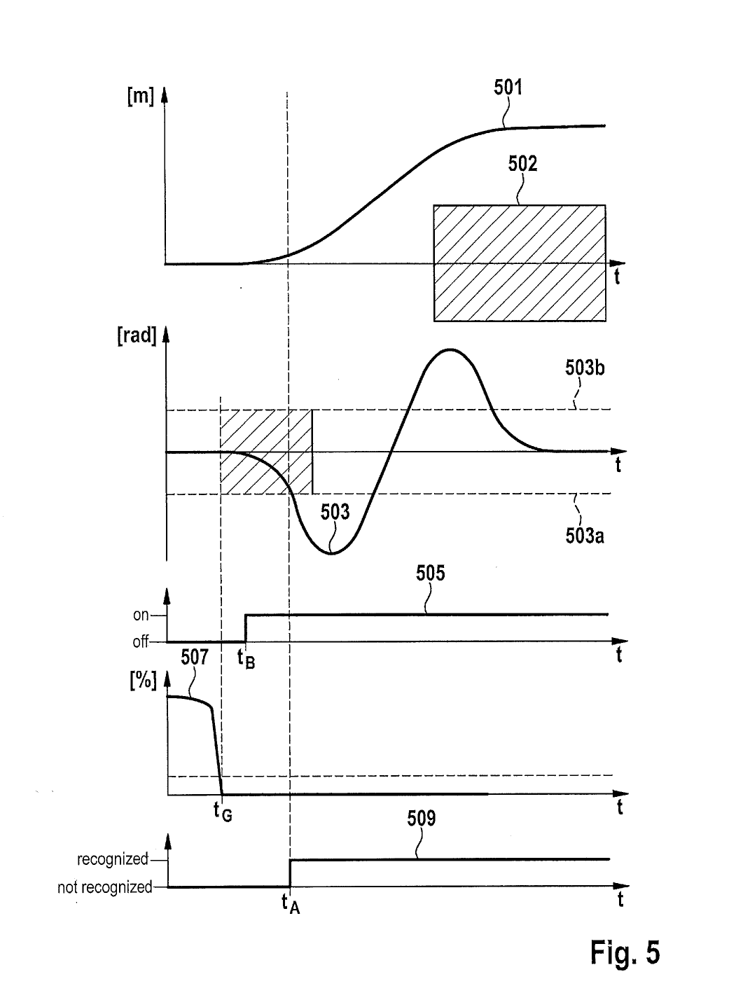

FIG. 5 shows various graphic representations for each possible criterion, in order to detect or recognize a vehicle maneuver as a vehicle avoidance maneuver. The individual graphs are characterized in FIG. 5 by reference numerals 501, 503, 505, 507 and 509. The respective abscissa represents curve t over time in arbitrary units.

According to graph 501, an avoidance trajectory of the vehicle, with respect to an obstacle shown here symbolically, is shown having reference numeral 502. This being the case, on the y axis a transverse offset of the vehicle in arbitrary units, such as meters, is shown with respect to obstacle 502.

According to graph 503, a curve over time of the steering angle is shown in rads. What is also shown is furthermore two threshold values 503a and 503b, which are thus driver steering angle threshold values, in this case.

According to graph 505, one may see an operating state of a brake light. At point t_{B}, the driver operates the brake pedal, so that the brake pedal goes into an on-operating state, that is, the brake light glows.

According to graph 507, a curve over time of the required propulsion power is shown. This correlates as a rule with a gas pedal position. At this time t_{G}, the required propulsion power amounts to 0% of the maximum propulsion power. This therefore means particularly that the gas pedal is not being operated. That being the case, it is located in a non-operated position.

Graph 509 shows, according to its time axis, at what time, comparatively or relatively to the further curves over time, according to graphs 501, 503, 505 and 507 the vehicle maneuver has been detected as a vehicle avoidance maneuver. The time that is relevant in this instance is designated by t_{A}, where “A” stands for “avoidance maneuver”.

For t<t_{A}, the vehicle maneuver has not yet been detected or classified as a vehicle avoidance maneuver, although already at time t_{G}, where t_{G}<t_{A}, the gas pedal is no longer being operated. Also at time t_{B}, where t_{B}<t_{A}, the brake light is in an on-operating state, without this being sufficient, for the vehicle maneuver to be classified as a vehicle avoidance maneuver. Rather, in particular, the driver steering angle has to exceed driver steering angle threshold value 503a in the negative direction for the vehicle maneuver to be classified as a vehicle avoidance maneuver.

Thus, because of the safe and early activation (that is particularly driver-based, since steering wheel interventions by the driver are recorded and evaluated), advantageously a robust activation of new assistance functions, which are able to support the driver in emergency avoidance maneuvers, is managed.

What is claimed is:

1. A method for operating a vehicle, comprising:
detecting a vehicle avoidance maneuver; and
activating a driver assistance system for a lateral vehicle dynamics control.

2. The method as recited in claim 1, wherein the detecting of the vehicle avoidance maneuver includes recording a driver steering angle which is greater than a predetermined driver steering angle threshold value.

3. The method as recited in claim 1, wherein the detecting of the vehicle avoidance maneuver includes recording of a low-pass filtered steering wheel angular velocity which is greater than a predetermined steering wheel angular velocity threshold value.

4. The method as recited in claim 1, wherein the detection of the vehicle avoidance maneuver includes recording a required propulsion power which is less than a predetermined propulsion power threshold value.

5. The method as recited in claim 1, wherein the detecting of the vehicle avoidance maneuver includes recording a predetermined operating state of a signaling device of the vehicle.

6. The method as recited in claim 5, wherein the detecting of the vehicle avoidance maneuver includes recording of an off-operating state of a direction indicator of the vehicle.

7. The method as recited in claim 5, wherein the detecting of the vehicle avoidance maneuver includes recording an on-operating state of a brake light of the vehicle.

8. A device for operating a vehicle, comprising:
a detector configured to detect a vehicle avoidance maneuver of the vehicle; and
an activation device to activate a driver assistance system for a lateral vehicle dynamics control as a function of the detected vehicle avoidance maneuver.

9. A system for operating a vehicle, comprising:
a driver assistance system; and
a device for operating a vehicle, the device including a detector configured to detect a vehicle avoidance maneuver of the vehicle, and an activation device to activate the driver assistance system for a lateral vehicle dynamics control as a function of the detected vehicle avoidance maneuver.

10. A computer readable storage medium storing a computer program for operating a vehicle, the program code, when executed by a computer, causing the computer to perform the steps of:
detecting a vehicle avoidance maneuver; and
activating a driver assistance system for a lateral vehicle dynamics control.
